(19) United States
(12) Patent Application Publication
(10) Pub. No.: US 2021/0122028 A1
(43) Pub. Date: Apr. 29, 2021

(54) SOCKET SET HOLDER

(71) Applicant: Alltrade Tools, LLC, Cypress, CA (US)

(72) Inventors: Hector R. Hernandez, JR., Fullerton, CA (US); Greg Livingston, Huntington Beach, CA (US); Eric Hennings, Anaheim, CA (US)

(73) Assignee: Alltrade Tools, LLC, Cypress, CA (US)

(21) Appl. No.: 16/664,569

(22) Filed: Oct. 25, 2019

(51) Int. Cl. B25H 3/00; B25H 3/06; B25H 3/04

(52) U.S. Cl. CPC B25H 3/006; B25H 3/04; B25H 3/06

(57) ABSTRACT

A socket set holder comprising a lower tray, a rail, and plurality of retainers. Each retainer comprises a post sized to fit within a central bore of a socket, a left slot and a right slot sized to receive left and right elongate edges of the rail, whereby each retainer is slideable along the rail while being vertically attached to the rail. An upper barrier comprising a central slot extending through the upper barrier, the central slot being sized to receive a plurality of vertically oriented sockets that each have an internal bore of standard configuration. Wherein, the upper barrier is attached to the lower tray, thereby trapping the rail and the retainers in an immobile condition in relation to the lower tray and the upper barrier.

### BACKGROUND

It is well known to store cylindrical objects and tools such as sockets in sets of varying calibration. The prior art has developed a number of systems for conveniently storing such tool sets together in a convenient “pack” so that the correct size socket may be found at a moment's notice. Some systems store the tools lying horizontally in a group, collected together in a case with a closeable lid. Some are held together by magnetic force. Some systems have been developed to allow the tools to be stored vertically, so that their tips can be easily seen, and the correct size can be seen and returned to the correct place. Typically, such systems include a fixed location hole or peg, for inserting or installing the socket.

However, problems remain in the art. One of the problems arises during the manufacturing process which produces systems for storing cylindrical tools. Where a manufacturer sells many different types and sizes of tools, there will be a need for many different types and sizes of tool holder. Making different types and sizes of tool holder adds to the cost of producing and selling different tool types.

Thus, there is a need in the art for a tool holder that can be produced on mass, and yet which can be used in conjunction with many different tool sets of different types and sizes arranged in different configurations. The present invention addresses these and other needs.

### SUMMARY OF THE INVENTION

In a preferred embodiment, the invention is a socket set holder comprising a lower tray having a generally planar surface and a first elongate rectangular outline. The invention further includes a rail comprising a generally planar surface, and a second elongate rectangular outline sized to fit entirely within the first elongate rectangular outline. The rail further includes a left elongate edge, a right elongate edge, and a plurality of retainers. Each of the plurality of retainers comprises a post sized to fit within a central bore of a socket that has an internal bore of standard configuration. The retainers further comprise a left slot and a right slot, wherein the left slot is sized to receive the left elongate edge of the rail, and the right slot is sized to receive the right elongate edge of the rail, whereby each of the plurality of retainers is slideable along the rail while being vertically attached to the rail. The invention of this embodiment further includes an upper barrier comprising a third elongate rectangular outline sized to mate with the first elongate rectangular outline. The upper barrier also defines a central slot extending through the upper barrier between a lower surface and an upper surface, the central slot being bounded by a left side wall and a right side wall, the central slot being sized to receive a plurality of vertically oriented sockets that each have an internal bore of standard configuration. Under this configuration, the upper barrier is attached to the lower tray, thereby trapping the rail and the plurality of retainers in an immobile condition in relation to the upper barrier and the lower tray.

In some embodiments of the socket set holder, the lower tray may include a first downturn having a first length and extending adjacent a perimeter of the first elongate rectangular outline, and the upper barrier may include a second downturn having a second length extending adjacent a perimeter of the third elongate rectangular outline. Under this configuration, the second length is greater than the first length, whereby the first downturn is positioned outside the second downturn.

In further embodiments, the post may have a square top, and in yet further embodiments, the post may be wrapped in a compressible material. In further embodiments, a ball may be partially embedded within the post, the ball being spring biased away from the post.

In other embodiments of the socket set holder, the left side wall and the right side wall each have a height of a first dimension, and the lower tray has a width of a second dimension, wherein the first dimension is in a range of between 0.8 to 1.2 times the second dimension.

In another aspect, the invention is a method for assembling a socket set holder. The method comprises: providing a lower tray having a generally planar surface; providing a rail comprising a planar surface with a left elongate edge and a right elongate edge; and, providing a plurality of retainers, each of the plurality of retainers configured to support a socket having a standard internal bore, and each of the plurality of retainers having and a left slot and a right slot. The method further includes, for each of the plurality of retainers, inserting the left elongate edge within the left slot and inserting the right elongate edge within the right slot, and further includes sliding each of the plurality of retainers along the rail, so as to achieve an elected spacing between the plurality of retainers. The method further includes providing an upper barrier comprising a central slot extending through the upper barrier between a lower surface and an upper surface of the upper barrier. Each of the plurality of retainers is inserted through the central slot. The rail is trapped between the lower tray and the upper barrier, and the upper barrier is connected to the lower tray.

In some embodiments, connecting the upper barrier to the lower tray includes positioning a perimeter of a downturn on the upper barrier over a perimeter of a downturn on the lower tray. In other embodiments, method further includes applying an adhesive between the upper barrier and the lower tray. In yet further embodiments, positioning a perimeter of a downturn on the upper barrier over a perimeter of a downturn on the lower tray includes developing a ring tension in the downturn on the upper barrier. In again further embodiments, positioning a perimeter of a downturn on the upper barrier over a perimeter of a downturn on the lower tray includes developing a ring compression in the downturn on the lower tray. And in yet again further embodiments, trapping the rail between the lower tray and the upper barrier includes trapping the rail such that the rail is immovable in relation to the lower tray and the upper barrier.

### BRIEF DESCRIPTION OF THE DRAWINGS

FIG. 1 is a vertical perspective view of a component of a socket set holder that has features of the invention and of a kind that is shown in FIG. 7.

FIG. 2 is a vertical perspective view of an assembly of components of a socket set holder that has features of the invention, of a kind that is shown in FIG. 7, showing how sockets may be stored in relation to the assembly.

FIG. 3 is a vertical perspective view of the assembly of FIG. 2, showing additional sockets stored in relation to the assembly.

FIG. 4 is a partial view of the assembly of FIGS. 2 and 3, shown from above.

FIG. 5 is a partially exploded view shown from above of the socket set holder shown in FIG. 7.

FIG. 6 is a partially assembled view shown from the side of the socket set holder of FIG. 7.

FIG. 7 is a side perspective view of a socket set holder having features of the invention.

### DETAILED DESCRIPTION OF THE PREFERRED EMBODIMENTS

With reference to the figures, the invention is a socket set holder 100 as described in conjunction with the figures, which reveal features of the invention. Features of the invention are described starting with the smaller building blocks of the invention, and building up to the entire invention.

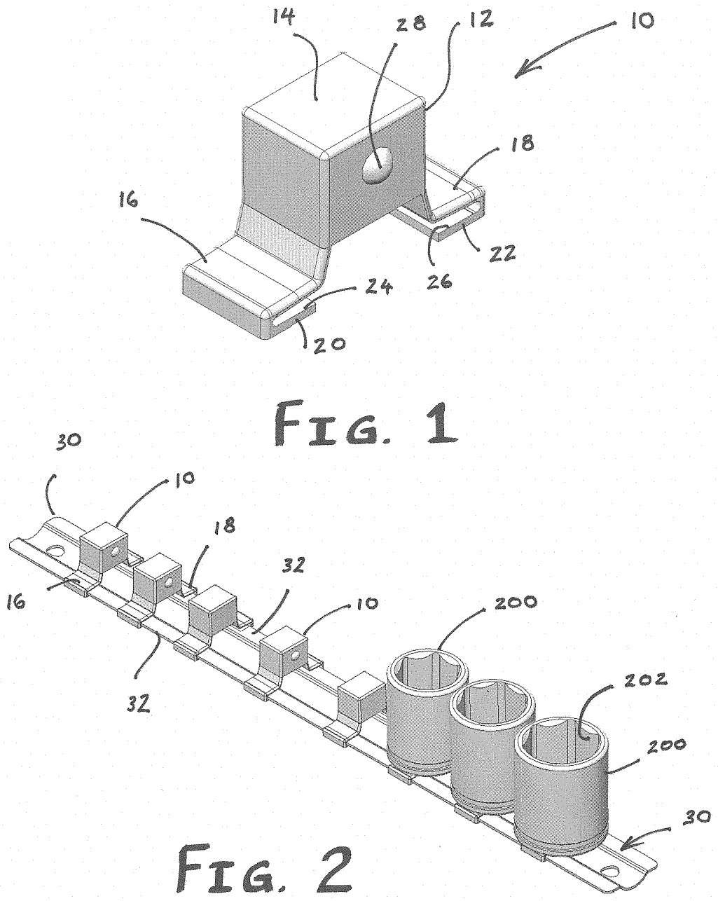

FIG. 1 shows a retainer 10, configured to hold a single socket 200 in a stationary position in relation to the socket set holder 100. As shown, the retainer 10 comprises a post 12 which has, as viewed from above, a square section. The tower has a top surface 14, with square outline. The retainer 10, has at its base a left grasper 16 and a right grasper 18. The left grasper 16 has a left support flange 20, and the right grasper has a right support flange 22. The left flange is set below the left grasper 16 to provide a left slot 24 and the right flange is set below the right grasper 18 to provide a right slot 26. A spring loaded ball 28 may be positioned in a vertical face of the post 12. The ball acts as a detent, configured to mate with a recess in a socket 200, which is provided in the socket to mate also with a similar ball mounted on a drive shaft when the socket is in use. In an alternative embodiment, the post may be sized to produce a friction fit with the bore 202 of the socket, and in such an embodiment, the post may be wrapped with a compressible rubber or polymer to provide an enhanced mechanical friction fit arrangement with the socket 200.

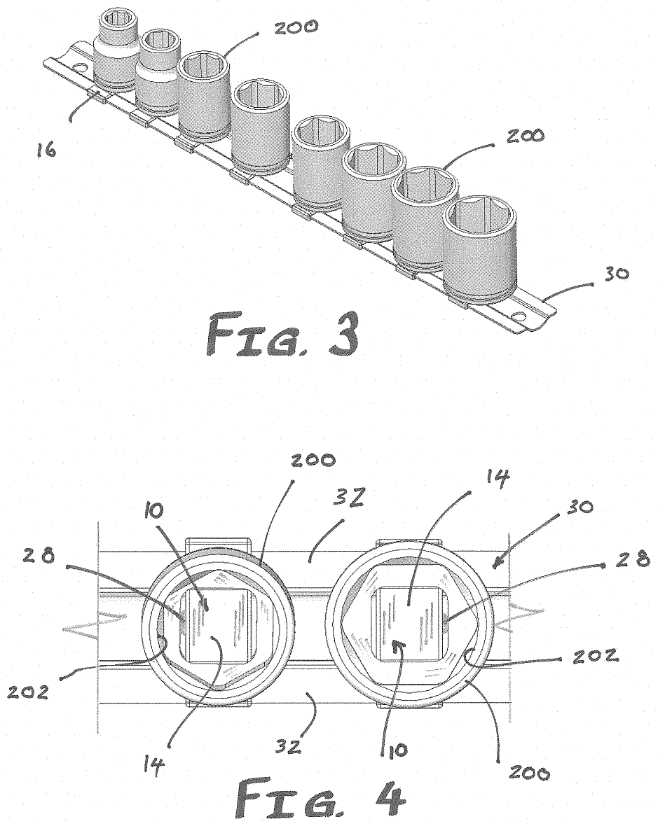

Moving now to FIG. 2, it is shown how a rail 30 is provided, made of a rigid material such as metal, or a stiff polymer. The rail may be extruded or molded. A major feature of the rail 30 is that it comprises edge flanges 32 on both the left and the right sides of the rail. The left and right edge flanges 32 are sized to be able to fit snugly within the left slot 24 and the right slot 26.

Based on the structure of the rail 20 and the retainer 10, a plurality of retainers 10 may be slid onto the end of the rail 32, and slid all the way to the other side of the rail so as to be distributed over the length of the rail. FIG. 2 shows a total of eight retainers 10 mounted on the rail, and only three sockets 200 mounted on three retainers respectively. FIG. 3 is similar to FIG. 2, but shows that all the retainers (not fully visible in this view) have been mounted by a socket 200.

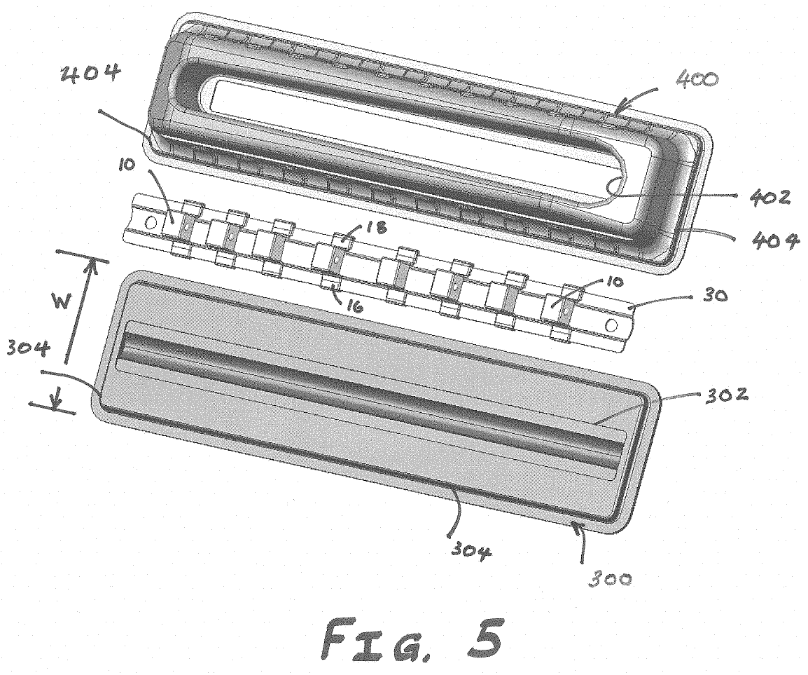

FIG. 4 shows in more detail the relationship between the rail 30, a retainer 10, and a socket 200. The top 14 of the retainer is inserted up into an inner bore of the socket. The ball 28 of the retainer is biased toward the inner bore 202 of the socket 200, and is received into a negative detent which is shaped to mate with the ball 28. This configuration, in conjunction with the internal spring (not shown) provides an outward bias to the ball, locks the socket onto the retainer so that it is electively removable by a user.

The same feature may be provided for each of the eight sockets, so that each socket 200 may be removably locked onto each retainer 10, and each retainer 10 may be attached to the rail 30 as described above. As mentioned above, in an alternative embodiment, the post 12 may be wrapped with a compressible polymer or rubber, to provide a friction fit between the post 12 and the inner bore 202 of the socket 200.

Referring to FIGS. 5-7, it is shown how provision is made for the rail 32 to be stabilized against rotation in use, so that, in use, the sockets may stand vertically on a work bench or table without flipping over sideways when bumped. To this end, a lower tray 300 is provided. The lower tray 300 may be heat molded from a flat sheet of polymer or plastic. The lower tray 300 is substantially a flat sheet of plastic, in which the perimeter edges may be stiffened by being provided with a downturn 304 adjacent the edges of the perimeter. Further, a recess 302 (FIG. 5) is provided, and shaped to snugly received the rail 30, so that the upper surface of the rail 30 lies in the same plane as the upper most surface of the lower tray 300.

Finally, provision is made to give extra stability against lateral movement to the sides of the sockets 200 after they are mounted on the retainers 10 and the rail is installed on the lower tray 300. For this purpose, an upper barrier 400 is provided.

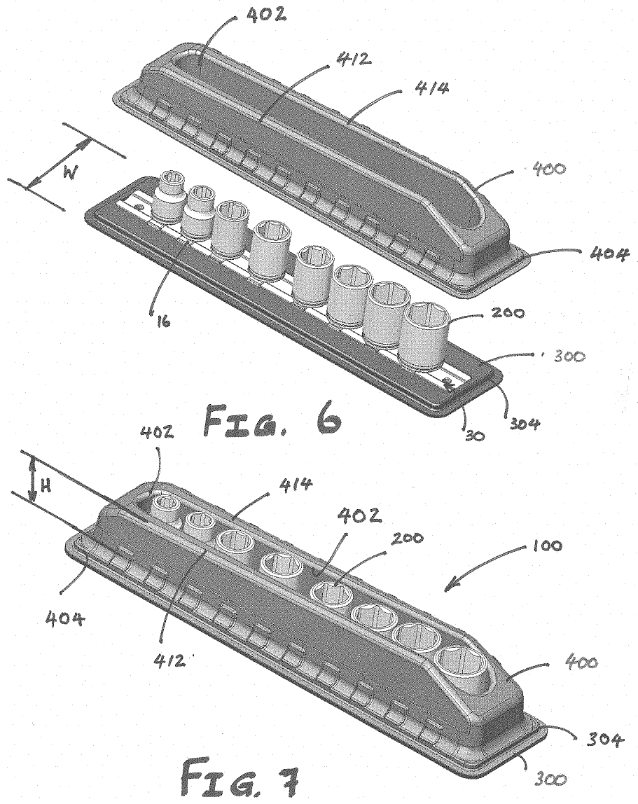

The upper barrier 400 may be heat molded from a flat sheet of polymer or plastic, in which the perimeter edges are stiffened by being provided with a downturn 404 adjacent the edges. A significant feature of the upper barrier is an elongate slot 402 which extends substantially from one end of the barrier to the other, and has a width that is sized to snugly receive a row of sockets (e.g. sockets 200) extending upward from the rail 30 which rests on the lower tray 300. The upper barrier 400 is provided, extending along the edges of the elongate slot 402, with a left side wall 412 and a right side wall 414. The left and right side walls 412, 414 provide additional security and stability against the sockets being dislodged from their position inside the slot 402 of the upper barrier 400 in the event of an impact to the socket set retainer 100 while it rests on a bench top. The side walls preferably extend upwardly by an amount which is approximately equal to the width of the upper barrier 400. Preferably, the left and the right side walls each have a maximum height (“H”) of first dimension measured from the lowest point on the upper barrier 400 to the highest point on the left and right side walls; and the lower tray has a width (“W”) of second dimension (FIG. 6). Preferably, the first dimension is in a range of between 0.8 to 1.2 times the second dimension. It will be appreciated that the sockets preferably have a length which is at least as great as the depth of the slot 402, and the sockets may extend upwardly to be longer than the depth of the slot.

The upper barrier 400 is attached to the lower tray 300, to trap the rail and the retainers immovably within. This attachment may be achieved by fitting the downturn 404 of the upper barrier 400 around the downturns 304 of the lower tray. FIGS. 6-7. By carefully sizing the perimeter of the downturn 404 of the upper barrier to be only just slightly larger than the perimeter of the downturn 304 of the lower tray, a ring tension can be generated in the downturn 404 of the upper barrier, and a ring compression in the downturn 304 of the lower tray, which enhances the attachment between the downturn 404 and downturn 304. Additionally, a small amount of adhesive may be applied to the connection, and/or a staple may be added to mechanically attached the upper barrier 400 to the lower tray 300.

The following novel advantages are provided by the socket set holder 100 of the present invention. The retainers 10 can be arranged to be at any spacing along the rail 30. Thus, the same rail, and the same retainers can be manufactured for a large number of sockets, tools, or other equipment. Where the size of the tool calls for a larger or a smaller spacing between the retainers 10, that spacing can be provided using the same rail and retainer system for all spacings. During assembly, the spacing of the retainers 10 on the rail 30 can be set to any dimension that is necessitated by the socket set arrangement. Furthermore, the lower tray 300 can be provided, without changing its shape, for a large number of different tools, sockets, or products. The upper barrier, however, may require modification to accommodate sockets or tools that are broader or narrower. But the general effect of the design is that only this one element, the upper barrier 400, may require alteration to accommodate a totally different product, the other elements can all be used, but adjusted in position to accommodate a different product set.

Accordingly, there is described a novel system and method that addresses needs and shortcomings in the art. The present invention may, of course, be carried out in other specific ways than those herein set forth without departing from the essential characteristics of the invention. The present embodiments are, therefore, to be considered in all respects as illustrative and not restrictive, while the scope of the invention is set forth in the claims that follow.

We claim:

1. A socket set holder comprising:
a lower tray having a generally planar surface and a first elongate rectangular outline;
a rail comprising:
a generally planar surface,
a second elongate rectangular outline sized to fit entirely within the first elongate rectangular outline;
a left elongate edge; and
a right elongate edge;
a plurality of retainers, each of the plurality of retainers comprising:
a post sized to fit within a central bore of a socket that has an internal bore of standard configuration; and
a left slot and a right slot, wherein the left slot is sized to receive the left elongate edge of the rail, and the right slot is sized to receive the right elongate edge of the rail, whereby each of the plurality of retainers is slideable along the rail while being vertically attached to the rail;
an upper barrier comprising:
a third elongate rectangular outline sized to mate with the first elongate rectangular outline; and
a central slot extending through the upper barrier between a lower surface and an upper surface, the central slot being bounded by a left side wall and a right side wall, the central slot being sized to receive a plurality of vertically oriented sockets that each have an internal bore of standard configuration; and
wherein, the upper barrier is attached to the lower tray, thereby trapping the rail and the plurality of retainers in an immobile condition in relation to the upper barrier and the lower tray.

2. The socket set holder of claim 1, wherein,
the lower tray includes a first downturn having a first length and extending adjacent a perimeter of the first elongate rectangular outline, and
the upper barrier includes a second downturn having a second length extending adjacent a perimeter of the third elongate rectangular outline, and
further wherein the second length is greater than the first length, whereby the first downturn is positioned outside the second downturn.

3. The socket set holder of claim 1, wherein the post has a square top.

4. The socket set holder of claim 1, wherein the post is wrapped in a compressible material.

5. The socket set holder of claim 1, further including a ball partially embedded within the post, the ball being spring biased away from the post.

6. The socket set holder of claim 1, wherein the left side wall and the right side wall each have a height of a first dimension, and the lower tray has a width of a second dimension, and further wherein the first dimension is in a range of between 0.8 to 1.2 times the second dimension.

7. A method for assembling a socket set holder comprising:
providing a lower tray having a generally planar surface;
providing a rail comprising a planar surface with a left elongate edge and a right elongate edge;
providing a plurality of retainers, each of the plurality of retainers configured to support a socket having a standard internal bore, and each of the plurality of retainers having and a left slot and a right slot;
for each of the plurality of retainers, inserting the left elongate edge within the left slot and inserting the right elongate edge within the right slot;
sliding each of the plurality of retainers along the rail, and achieving an elected spacing between the plurality of retainers;
providing an upper barrier comprising a central slot extending through the upper barrier between a lower surface and an upper surface of the upper barrier;
inserting each of the plurality of retainers through the central slot;
trapping the rail between the lower tray and the upper barrier; and
connecting the upper barrier to the lower tray.

8. The method of claim 7, wherein connecting the upper barrier to the lower tray includes positioning a perimeter of a downturn on the upper barrier over a perimeter of a downturn on the lower tray.

9. The method of claim 8, further including applying an adhesive between the upper barrier and the lower tray.

10. The method of claim 8, wherein positioning a perimeter of a downturn on the upper barrier over a perimeter of a downturn on the lower tray includes developing a ring tension in the downturn on the upper barrier.

11. The method of claim 8, wherein positioning a perimeter of a downturn on the upper barrier over a perimeter of a downturn on the lower tray includes developing a ring compression in the downturn on the lower tray.

12. The method of claim 7, wherein trapping the rail between the lower tray and the upper barrier includes trapping the rail such that the rail is immovable in relation to the lower tray and the upper barrier.
